(19) United States
(12) Patent Application Publication
(10) Pub. No.: US 2025/0273913 A1
(43) Pub. Date: Aug. 28, 2025

(54) ELECTRICAL CONNECTOR WITH POWER ACTIVATION AFTER MATING

(71) Applicant: VSO ELECTRONICS CO., LTD. (R.O.C.), New Taipei City (TW)

(72) Inventors: CHUNG CHENG CHIEN, New Taipei City (TW); YU-WEI PERNG, New Taipei City (TW); CHI CHANG CHEN, New Taipei City (TW)

(21) Appl. No.: 18/957,764

(22) Filed: Nov. 24, 2024

(30) Foreign Application Priority Data
Feb. 23, 2024 (TW) 113201907

(51) Int. Cl. H01R 13/703; H01R 13/24

(52) U.S. Cl. CPC H01R 13/7032; H01R 13/2457

(57) ABSTRACT

An electrical connector with power activation after mating, which includes an insulation structure, a plurality of first power terminals, a plurality of second power terminals, a first activating terminal, a second activating terminal, a first detection terminal and a second detection terminal. The first detecting terminal is arranged adjacent to the first activating terminal, and the second detecting terminal is arranged adjacent to the second activating terminal. A counterpart electrical connector contacts the first power terminals and the second power terminals prior to the first activating terminal and the second activating terminals. The first activating terminal and the second activating terminal are pressed to contact the first detecting terminal and the second detecting terminal, whereby a high voltage side is conducted to the first power terminals, and a low voltage side is conducted to the second power terminals.

### BACKGROUND OF THE INVENTION

### Field of the Invention

The invention relates to an electrical connector, and more particularly to an electrical connector with power activation after mating.

### Description of the Related Art

Electrical connectors are used to electrically connect electronic devices and electronic modules for transmission of electronic signals or electrical power. Certain electrical connectors for electrical power transmission are connected to a power source of high voltage, such as high voltage electrical connector of electrical vehicles. When a male electrical connector mates with a female electrical connector, before terminals of the male electrical connector are contact terminals of the female electrical connector, high electrical potential between the terminals will penetrate air to generate plasma, whereby an arc is generated between the terminals of the male electrical connector and the terminals of the female electrical connector. The arc may damage the electrical connector.

### BRIEF SUMMARY OF THE INVENTION

An object of the invention is to provide an electrical connector with power activation after mating. Power supply is activated after terminals of a male electrical connector and terminals of a female electrical connector, whereby the problem of arc generation is prevented.

The invention provides an electrical connector with power activation after mating. The electrical connector with power activation after mating in accordance with an exemplary embodiment of the invention includes an insulation structure having a base, a first plate and a second plate, wherein the first plate and the second plate are connected to the base and extend along a first direction, and a gap exists between the first plate and the second plate to form a mating space; a plurality of first power terminals disposed on the first plate and arranged in a first row along a second direction, the first power terminals are electrically connected and front ends of the first power terminals are aligned, and the second direction is perpendicular to the first direction; a plurality of second power terminals disposed on the second plate and arranged in a second row along the second direction, the second power terminals are electrically connected and front ends of the second power terminals are aligned; a first activating terminal disposed on the first plate and arranged in the first row, wherein the first activation terminal is electrically connected to the first power terminals, a projection of a front end of the first activating terminal along a third direction is distanced to a projection of the front ends of the first power terminals along the third direction; a second activating terminal disposed on the second plate and arranged in the second row, wherein the second activation terminal is electrically connected to the second power terminals, a projection of a front end of the second activating terminal along the third direction is distanced to a projection of the front ends of the second power terminals along the third direction; a first detecting terminal adjacent to the first activating terminal and disposed outsides the mating space; a second detecting terminal adjacent to the second activating terminal and disposed outsides the mating space; wherein when a counterpart electrical connector is inserted into the mating space, terminals of the counterpart electrical connector contact the first power terminals and the second terminals prior to the first activating terminals and the second activating terminals, whereby the first activating terminal deform elastically to contact the first detecting terminal to conduct a high voltage side to the first power terminals, and the second activating terminal deform elastically to contact the second detecting terminal to conduct a low voltage side to the second power terminals.

In another exemplary embodiment, the electrical connector of the invention further includes two first joining members and two first electrically-connecting members connected to the first joining members, and each of the first joining member is connected to the plurality of first power terminals.

In yet another exemplary embodiment, the first joining members are stacked and secured to the first plate, and the first electrically-connecting members are stacked and abut each other.

In another exemplary embodiment, the electrical connector of the invention further includes two second joining members and two second electrically-connecting members connected to the first joining members, each second joining member is connected to the plurality of the second power terminals.

In yet another exemplary embodiment, the second joining members are stacked and secured to the second plate, and the second electrically-connecting members are stacked and abut each other.

In another exemplary embodiment, the first activating member is disposed at the outermost position of the first row, and the first activating terminal is connected to the first joining member; the second activating member is disposed at the outermost position of the second row, and the second activating terminal is connected to the second joining member.

In yet another exemplary embodiment, the first detecting terminal includes a first contacting portion, a first securing portion, and a first electrically-connecting portion, the first contacting portion is disposed on one side of the first activating terminal, and a projection of the first contacting portion along the third direction overlaps a projection of the first activating terminal, the first securing portion is secured to the base, and the first electrically-connecting portion is connected to the first securing portion; the second detecting terminal includes a second contacting portion, a second securing portion, and a second electrically-connecting portion, the second contacting portion is disposed on one side of the second activating terminal, and a projection of the second contacting portion along the third direction overlaps a projection of the second activating terminal, the second securing portion is secured to the base, and the second electrically-connecting portion is connected to the second securing portion.

In another exemplary embodiment, a lateral side of the first contacting portion is aligned with a lateral side of the first activating terminal away from the first power terminals, and a lateral side of the second contacting portion is aligned with a lateral side of the second activating terminal away from the second power terminals.

In yet another exemplary embodiment, the electrical connector of the invention further including a plurality of first grounding terminals and a plurality of second grounding terminals, wherein the first grounding terminals are disposed on the first plate and opposite to the first power terminals, and the second ground terminals are disposed on the second plate and opposite to the second power terminals.

In another exemplary embodiment, the first plate includes a plurality of first groove disposed on an upper surface and a lower surface of the first plate, the first grounding terminals are disposed in the first grooves on the upper surface, and the first power terminals are disposed in the first grooves on the lower surface; the second plate includes a plurality of second groove disposed on an upper surface and a lower surface of the second plate, the second grounding terminals are disposed in the second grooves on the upper surface, and the second power terminals are disposed in the second grooves on the lower surface.

The electrical connector of the invention includes the first activating terminal and the first detecting terminal, and a front end of the first activating terminal is distanced from a front end of the first power terminals, whereby the terminals of a counterpart electrical connector contact the first power terminals and the second power terminals prior to the first activating terminal during the mating of the counterpart electrical connector and the electrical connector of the invention. The first activating terminal deforms elastically to contact the first detecting terminal so as to conduct a high voltage side to the first power terminal and conduct a low voltage side to the second power terminal. Since power supply is activated after the mating the electrical connectors, the problem of arc generation occurring in the prior art is solved.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an electrical connector with power activation after mating of the present invention;

FIG. 2 is a cross section along a line A-A of FIG. 1;

FIG. 3 is a perspective view of the electrical connector eliminating a portion of the insulation structure of FIG. 1;

FIG. 4 is a perspective view of the electrical connector eliminating first grounding terminals and a portion of the insulation structure of FIG. 1;

FIG. 5 is a perspective view of a combination structure of the first power terminals, the second power terminals, the first activating terminal and the first detecting terminal;

FIG. 6 is an exploded view of FIG. 5; and

FIGS. 7, 8 and 9 are schematic views of mating of the counterpart electrical connector and the electrical connector of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

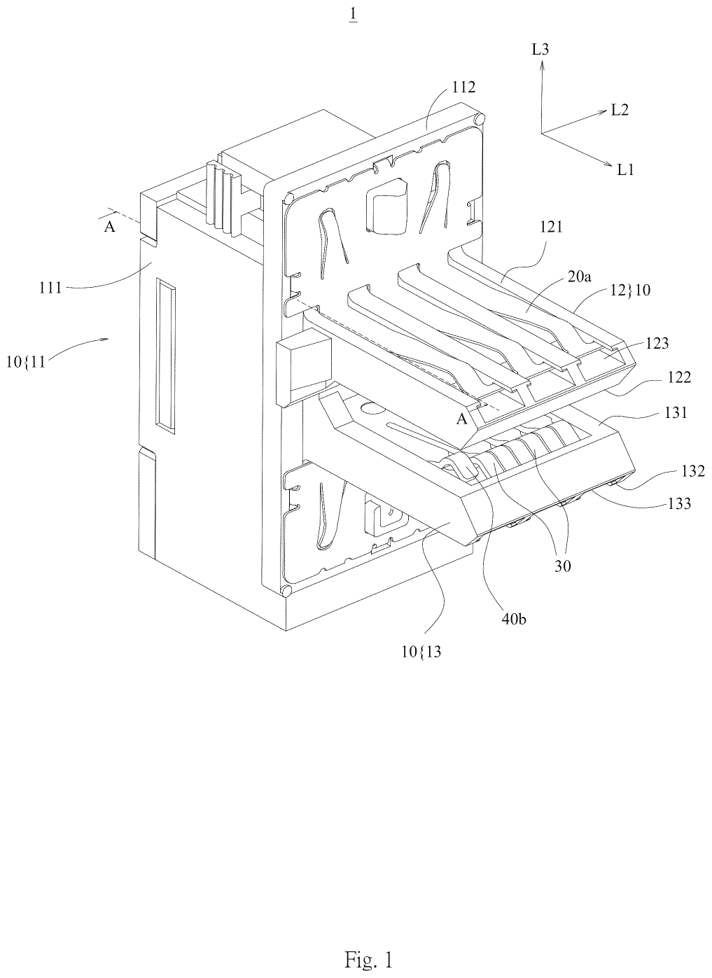

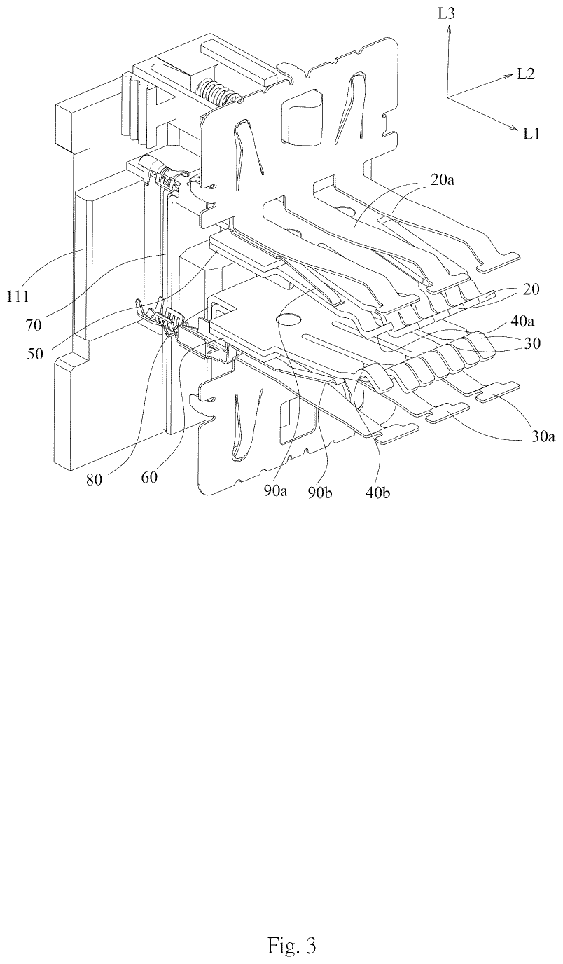

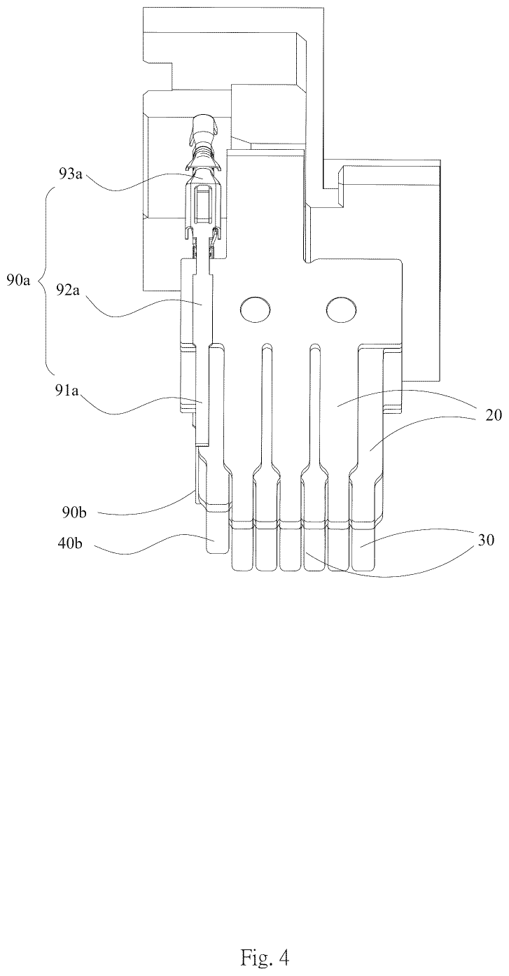

Referring to FIGS. 1, 2 and 3, an embodiment of an electrical connector with power activation after mating is disclosed. The electrical connector 1 of the embodiment includes an insulation structure 10, a plurality of first power terminals 20, a plurality of second power terminals 30, a first activating terminal 40a, a second activating terminal 40b, two first joining members 50, two second joining members 60, two first electrically-connecting terminal 70, two first electrically-connecting terminal 80, a first detecting terminal 90a, a second detecting terminal 90b, a plurality of first grounding terminals 20a and a plurality of second grounding terminals 30a. The electrical connector 1 of the embodiment is a female electrical connector for mating a male electrical connector.

The insulation structure 10 includes a base 11, a first plate 12 and a second plate 13. The base 11 includes a base main body 111 and a mounting plate portion 112 provided on one side of the base main body 111. An accommodation space is formed inside the base body 111 for accommodating a portion of the plurality of first power terminals 20 and the plurality of second power terminals 30. The first plate 12 and the second plate 13 are connected to the mounting plate portion 112 of the base 11 and are perpendicular to the mounting plate portion 112. The first plate 12 and the second plate 13 are parallel to each other and extend along a first direction L1, and a gap exists between the first plate 12 and the second plate 13 to form a mating space S. The first plate 12 has a first upper surface 121 and a first lower surface 122 opposite to the first upper surface 121. The first plate 12 includes a plurality of first grooves 123 respectively formed on the first upper surface 121 and the first lower surface 122. The second plate 13 has a second upper surface 131 and a second lower surface 132 opposite to the second lower surface 132. The second plate 13 includes a plurality of second grooves 133 respectively formed on the second upper surface 131 and the second lower surface 132. The first lower surface 122 of the first plate 12 is opposite to the second upper surface 131 of the second plate 13 and forms two limiting surfaces of the mating space S, which abut the first lower surface 122 and the second upper surface 13, thereby limiting and guiding the counterpart electrical connector (male electrical connector) during mating.

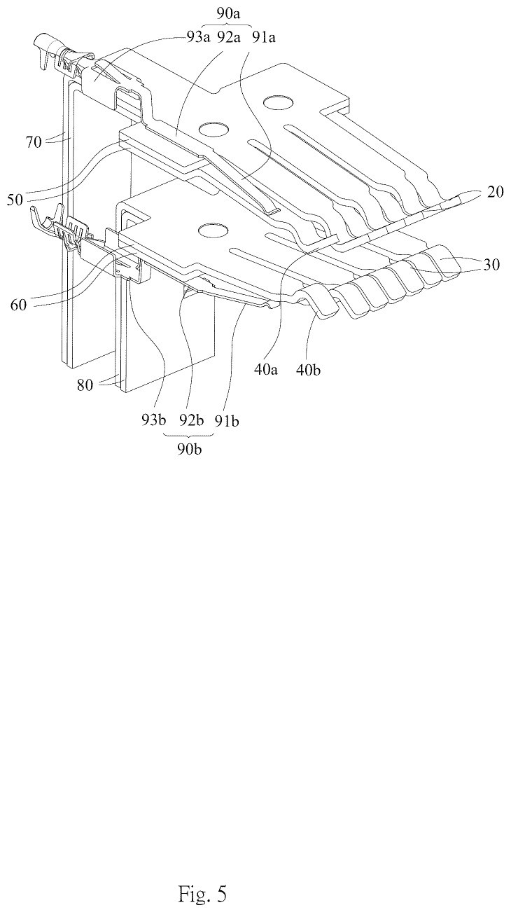

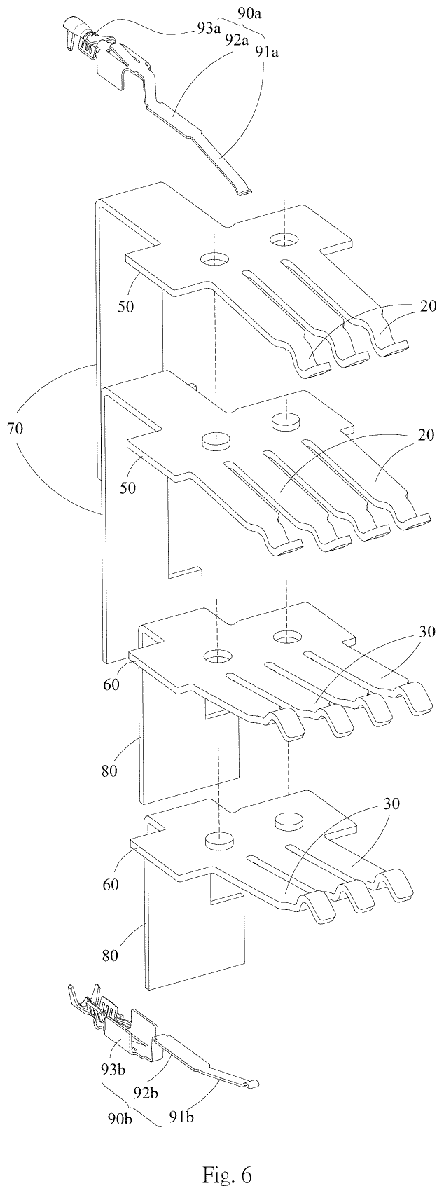

Referring to FIGS. 5 and 6, a plurality of first power terminals 20 are provided on the first plate 12 and arranged along a second direction L2 perpendicular to the first direction L1. The first power terminals 20 are located in the first groove 123 of the first lower surface 122. The first power terminal 20 has an elastic-arm structure and extends into the mating space S. The first power terminals 20 are parallel to each other and arranged in a first row, wherein the first power terminals 20 are electrically connected to each other, the front ends of the first power terminals are aligned with each other. The plurality of first power terminals 20 are divided into two groups and are respectively connected to two first joining members 50. The two first joining members 50 are stacked through an engaging structure constituted of the engaging posts and engaging holes, whereby the plurality of first power terminals 20 are electrically connected through the two first joining members 50. The two first electrically-connecting members 70 are respectively connected to the two first joining members 50. The two first electrically-connecting members 70 are used to form electrical connection with a high voltage side in the electronic device. The first electrically-connecting members 70 of this embodiment can be connected to the high voltage side through a switching element, such as a transistor switching element. In addition, the plurality of first power terminals 20, the first joining member 50 and the first electrically-connecting members 70 form an integrated structure, for example, through a stamping process and bending process.

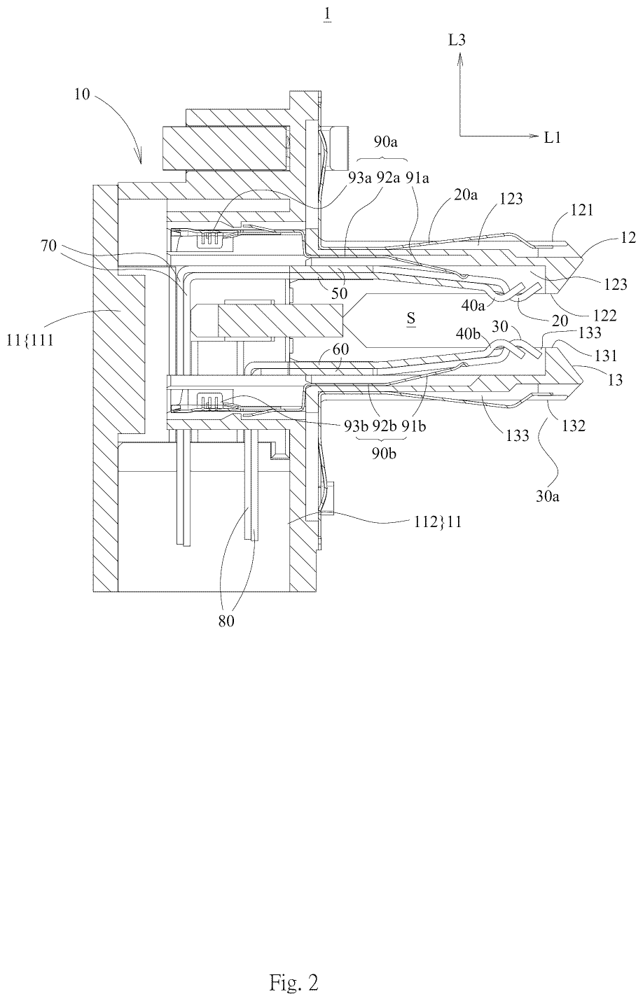

The first activating terminal 40a and the first power terminal 20 are all arranged in the first row, and the first activating terminal 40a is located at the outermost side of the first row. The first activating terminal 40a is connected to a first joining member 50, whereby the first activating terminal 40a is electrically connected to the first power terminals 20. As shown in FIG. 2, a projection of the front end of the first activating terminal 40a along the third direction L3 is distanced from a projection of the front end of the first power terminal 20 along the third direction L3, and the first activating terminal 40a is further away from a front end of the first plate 12 than the first power terminals 20. Similarly, the second activating terminal 40b and the second power terminal 30 are arranged in the second row, and the second activating terminal 40b is located at the outermost side of the second row. The second activating terminal 40b is connected to the first joining member 50, whereby the second activating terminal 40b is electrically connected to the second power terminal 30. As shown in FIG. 2, a projection of a front end of the second activating terminal 40b along the third direction L3 is distanced from a projection of a front end of the second power terminals 30 along the third direction L3, and the second activating terminal 40b is further away from the front end of the second plate 13 than the second power terminals 30. The third direction L3 is orthogonal to the first direction L1 and the second direction L2.

The plurality of second power terminals 30 are disposed in the second groove 133 formed on the second upper surface 131 of the second plate 13. The second power terminal 30 has an elastic-arm structure and extends into the mating space S. The second power terminals 30 are arranged along the second direction L2, the front ends of the second power terminals 30 are aligned with each other, and the projection of the front ends of the second power terminals 30 overlaps the front ends of the first power terminal 20 along the third direction L3. The plurality of second power terminals 30 are divided into two groups and are respectively connected to the two second joining members 60. The two second joining members 60 are stacked through an engaging structure constituted of engaging posts and engaging holes, whereby the plurality of second power terminals 30 are electrically connected through the two second joining members 60. The two second electrically connecting members 80 are respectively connected to the two second joining members 60, and the two second electrical connectors 80 are used to form electrical connections with low potential terminals in the electronic device. The second electrically-connecting members 80 of this embodiment can be connected to a high voltage side through a switching element, such as a transistor switching element. In addition, the plurality of second power terminals 30, a second combining member 60 and a second electrical connecting member 80 form an integrated structure, through a stamping process and a bending process for a metal trip.

Referring to FIGS. 2, 3, 5 and 6, the first detection terminal 90a is disposed adjacent to the first activating terminal 40a and located outside the mating space S. The first detection terminal 90a includes a first contact portion 91a, a first securing portion 92a and a first electrically-connecting portion 93a. The first contact portion 91a is disposed on one side of the first activating terminal 40a, and a projection of the first contact portion 91a along the third direction L3 overlaps a projection of the first activating terminal 40a along the third direction. The first securing portion 92a is secured to the base 112 of the insulation structure 10. In the base body 111, the first electrically-connecting portion 93a is connected to the first securing portion 92a, and the first electrically-connecting portion 93a can be connected to an electrical circuit in the electronic device through a lead. A lateral side of the first detection terminal 90a in this embodiment is aligned with a lateral side of the first activating terminal 40a away from the first power terminal 20.

The second detecting terminal 90b is disposed adjacent to the second activating terminal 40b and located outside the mating space S. The first detecting terminal 90b includes a second contact portion 91b, a second securing portion 92b and a second electrically-connecting portion 93b. The second contact portion 91b is disposed on one side of the second activating terminal 40a, and a projection of the second contact portion 91b along the third direction L3 overlaps a projection and the second activating terminal 40b along the third direction. The second securing portion 92b is secured to the base main body 111 of the base 11 of the insulation structure 10. The second electrically-connecting portion 93b is connected to the second securing portion 92b, and the second electrically-connecting portion 93b can be connected to an electrical circuit in the electronic device through a lead. In this embodiment, the side of the second detecting terminal 90b is aligned with the side of the second activating terminal 40b away from the second power terminal 30.

The first ground terminals 20a are disposed in the first groove 123 on the first upper surface 121 of the first plate 12. The first ground terminals 20a and the first power terminals 20 are disposed opposite on the first plate 12. The second ground terminal 30a is disposed in the second groove 133 on the second lower surface 132 of the second plate 13. The second ground terminals 30a and the second power terminals 30 are disposed opposite on the second plate 13. The plurality of first ground terminals 20a are electrically connected to each other and are disposed on the mounting plate portion 112 of the base 11 in an engaging manner. The plurality of second ground terminals 30a are electrically connected to each other and are disposed on the mounting plate portion 112 of the base 11 at an engaging manner.

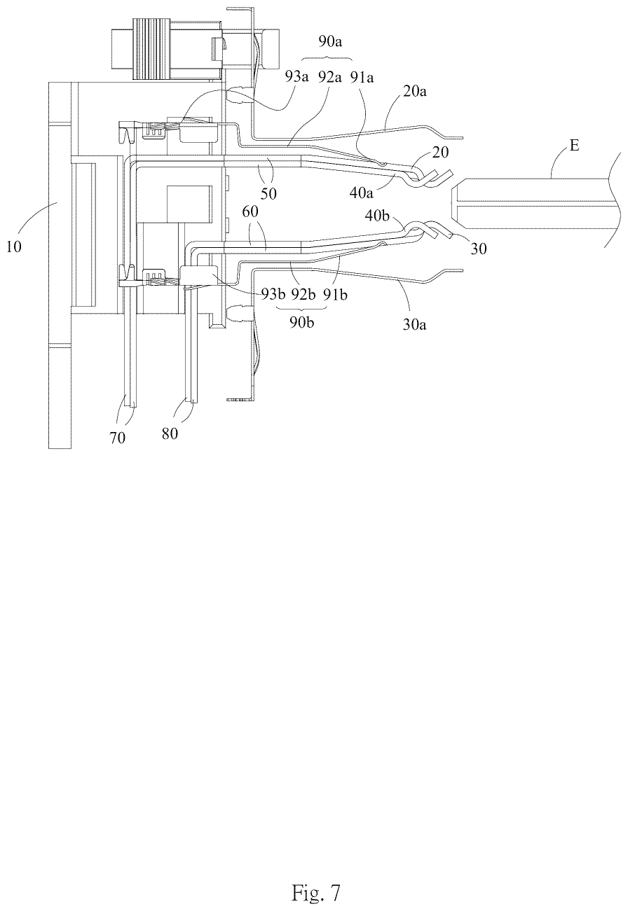

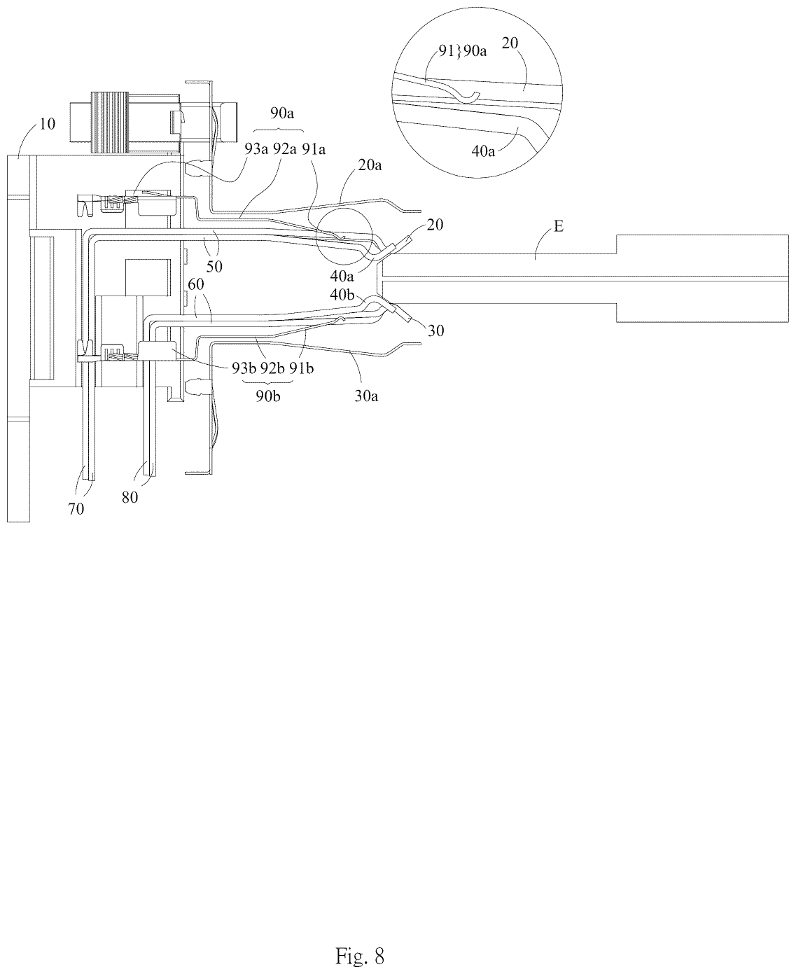

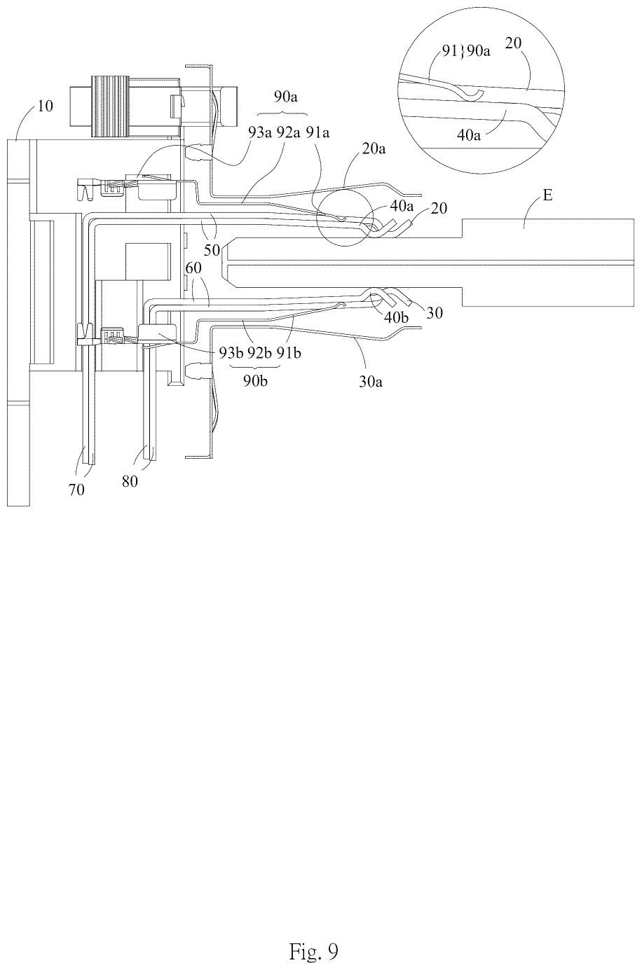

Referring to FIGS. 7, 8 and 9, as a counterpart electrical connector E (a male electrical connector) are inserted into the mating space S between the first plate 12 and the second plate 13, as shown in FIG. 8, the electrical connector E contacts the first power terminals 20 and the second power terminals 30 to push the first power terminals 20 and the second power terminals 30 causing elastic deformation. Then, the counterpart electrical connector E moves further to contact the first activating terminal 40, and the first activating terminal 40 is pressed to generate elastic deformation and contact the first detection terminal 90. The first activating terminal 40 contacts the first detection terminal 90 to enable the electrical circuit in the electronic device in a conductive state, thereby causing the high voltage side of the electronic device to conduct to the first power terminal 20, and the low potential terminal is conducted to the second power terminal 30. In this way, the switching element of the electronic device is triggered to connect the first power terminal 20 and the second power terminal 30 to the high voltage side and the low voltage side after the mating of the counterpart electrical connector and the electrical connector 1 of the present invention.

The electrical connector of the invention includes the first activating terminal and the first detecting terminal, and a front end of the first activating terminal is distanced from a front end of the first power terminals, whereby the terminals of a counterpart electrical connector contact the first power terminals and the second power terminals prior to the first activating terminal during the mating of the counterpart electrical connector and the electrical connector of the invention. The first activating terminal deforms elastically to contact the first detecting terminal so as to conduct a high voltage side to the first power terminal and conduct a low voltage side to the second power terminal. Since power supply is activated after the mating the electrical connectors, the problem of arc generation occurring in the prior art is solved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrical connector with power activation after mating, comprising:
an insulation structure having a base, a first plate and a second plate, wherein the first plate and the second plate are connected to the base and extend along a first direction, and a gap exists between the first plate and the second plate to form a mating space;
a plurality of first power terminals disposed on the first plate and arranged in a first row along a second direction, the first power terminals are electrically connected and front ends of the first power terminals are aligned, and the second direction is perpendicular to the first direction;
a plurality of second power terminals disposed on the second plate and arranged in a second row along the second direction, the second power terminals are electrically connected and front ends of the second power terminals are aligned;
a first activating terminal disposed on the first plate and arranged in the first row, wherein the first activation terminal is electrically connected to the first power terminals, a projection of a front end of the first activating terminal along a third direction is distanced to a projection of the front ends of the first power terminals along the third direction;
a second activating terminal disposed on the second plate and arranged in the second row, wherein the second activation terminal is electrically connected to the second power terminals, a projection of a front end of the second activating terminal along the third direction is distanced to a projection of the front ends of the second power terminals along the third direction;
a first detecting terminal adjacent to the first activating terminal and disposed outsides the mating space;
a second detecting terminal adjacent to the second activating terminal and disposed outsides the mating space;
wherein when a counterpart electrical connector is inserted into the mating space, terminals of the counterpart electrical connector contact the first power terminals and the second terminals prior to the first activating terminals and the second activating terminals, whereby the first activating terminal deform elastically to contact the first detecting terminal to conduct a high voltage side to the first power terminals, and the second activating terminal deform elastically to contact the second detecting terminal to conduct a low voltage side to the second power terminals.

2. The electrical connector as claimed in claim 1, further comprises two first joining members and two first electrically-connecting members connected to the first joining members, and each of the first joining member is connected to the plurality of first power terminals.

3. The electrical connector as claimed in claim 2, wherein the first joining members are stacked and secured to the first plate, and the first electrically-connecting members are stacked and abut each other.

4. The electrical connector as claimed in claim 2, wherein further comprises two second joining members and two second electrically-connecting members connected to the first joining members, each second joining member is connected to the plurality of the second power terminals.

5. The electrical connector as claimed in claim 4, wherein the second joining members are stacked and secured to the second plate, and the second electrically-connecting members are stacked and abut each other.

6. The electrical connector as claimed in claim 2, wherein the first activating member is disposed at the outermost position of the first row, and the first activating terminal is connected to the first joining member; the second activating member is disposed at the outermost position of the second row, and the second activating terminal is connected to the second joining member.

7. The electrical connector as claimed in claim 6, wherein the first detecting terminal comprises a first contacting portion, a first securing portion, and a first electrically-connecting portion, the first contacting portion is disposed on one side of the first activating terminal, and a projection of the first contacting portion along the third direction overlaps a projection of the first activating terminal, the first securing portion is secured to the base, and the first electrically-connecting portion is connected to the first securing portion; the second detecting terminal comprises a second contacting portion, a second securing portion, and a second electrically-connecting portion, the second contacting portion is disposed on one side of the second activating terminal, and a projection of the second contacting portion along the third direction overlaps a projection of the second activating terminal, the second securing portion is secured to the base, and the second electrically-connecting portion is connected to the second securing portion.

8. The electrical connector as claimed in claim 7, wherein a lateral side of the first contacting portion is aligned with a lateral side of the first activating terminal away from the first power terminals, and a lateral side of the second contacting portion is aligned with a lateral side of the second activating terminal away from the second power terminals.

9. The electrical connector as claimed in claim 1, further comprising a plurality of first grounding terminals and a plurality of second grounding terminals, wherein the first grounding terminals are disposed on the first plate and opposite to the first power terminals, and the second ground terminals are disposed on the second plate and opposite to the second power terminals.

10. The electrical connector as claimed in claim 9, wherein the first plate comprises a plurality of first groove disposed on an upper surface and a lower surface of the first plate, the first grounding terminals are disposed in the first grooves on the upper surface, and the first power terminals are disposed in the first grooves on the lower surface; the second plate comprises a plurality of second groove disposed on an upper surface and a lower surface of the second plate. the second grounding terminals are disposed in the second grooves on the upper surface, and the second power terminals are disposed in the second grooves on the lower surface.
